(19) United States
(12) Patent Application Publication
(10) Pub. No.: US 2008/0006567 A1
(43) Pub. Date: Jan. 10, 2008

(54) Advanced Purification System Utilizing Closed Water Area by Hollow Water Area (Utsuro)

(76) Inventor: Kazuaki Akai, Wakayama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/628,051

(22) PCT Filed: Jun. 3, 2004
(86) PCT No.: PCT/JP04/08236

§ 371 Date: Nov. 30, 2006

(51) Int. Cl. C02F 3/00; C02F 3/02; C02F 3/32

(52) U.S. Cl. 210/150; 210/170.09; 210/170.11; 210/602

(57) ABSTRACT

For purification of a water area, a closed water area enclosed by a dike, an embankment, a shoal, or a land area is formed outside a hollow water area formed by a contact oxidation dike having multigaps so as to provide a purification water pool having a retention capacity that can sufficiently retain a water quantity of clean water being discharged to an exterior water area as a result of a fall in the exterior water area. When the exterior water area rises in the water level, clean water reserved in the purification water pool again flows in the hollow water area through the contact oxidation dike so as to further clean the water in the hollow water area. By repeating these operations, the water in and out of the hollow water area is further purified, thus the water in the hollow water area is purified in an advanced manner.

### BACKGROUND OF THE INVENTION

1. Field of the Invention

An enclosed water area enclosed and shut off by a dike structure in a water area having changes in the water level is called utsuro (a hollow water area). The present invention relates to an advanced purification system utilizing a closed water area by a hollow water area for a high-level improvement in water quality of a closed water area and a common water area by providing a closed water area outside a hollow water area formed by a contact oxidation dike having multigaps in order to purify water areas.

2. Description of the Related Art

In 1981, the present inventor invented a technique for shutting off a purification water area by use of a breakwater dike having multigaps as PTC/JP82/00419 (JP-1806954B) “purification system for water area.” However, polluted water in an exterior water (sea) area is almost infinite in quantity and the conventional purification system for a water area alone did not have a profound effect on purification of interior and exterior water (sea) areas.

Therefore, the present inventor proposed a “purification system for exterior water area utilizing hollow water area” as JP 2001-17957A in 1999. This proposal is based on the “purification system for water area” invented earlier and is for further enclosing an outer framework thereof, providing a purification water pool, and retaining therein clean water that has permeated through a contact oxidation dike when the water level of an exterior water area falls so as to purify the exterior water area of the hollow water area.

The present invention has been made to create amore advanced serene purification water area by developing usage conditions of these background arts.

### SUMMARY OF THE INVENTION

The present invention is for converting inconsistencies of closed water areas that have been internationally viewed with suspicion as hotbeds of water area pollution so as to contribute to an advanced treatment of the water areas while making use of characteristics thereof.

As a result of forming a hollow water area 2 invented earlier, for which a water area to be purified is enclosed and shut off by a contact oxidation dike in a water area having changes in the water level, clean water that has permeated through a contact oxidation dike 1 flows out to an exterior water area when the water level of an exterior water area falls. It has been proposed to clean water in the periphery of an exterior water area of the hollow water area 2 by making use of this “purification system for water area” and further constructing, for purifying a water area utilizing characteristics of a closed water area, a closed water area by a shoal, a water channel, a dike, and the like shown in FIGS. 1 to 5 outside the contact oxidation dike 1 that has formed the hollow water area 2 and thereby installing a purification water pool 3 that reserves clean water flowed out to the exterior water area. However, since the purification water pool 3 being a closed water area is adjacent to a polluted water area of an exterior water area 4 or a land area, due to a contaminated water inflow from the exterior water area 4 or contaminated inflows of a river and polluted water such as rainwater from the land area, the purification water pool 3 is polluted. Therefore, by regulating usage conditions of this system, a further advanced water purification area can be created.

Therefore, in a relationship having a retention capacity Qb of the purification water pool 3 being a closed water area that can sufficiently retain a water quantity Qc of clean water permeated through the contact oxidation dike 1 flowing out to the exterior water area 4 as a result of a fall in the exterior water area 4, that is, Qb>Qc, where a total water contamination emission in the water area of the purification water pool 3 is provided as Σbi=B and a total purification capacity of the hollow water area 2 is provided as Σci=C, under a condition of B/C≦1, by setting the scale of the hollow water area 2 or practicing operations shown in the following (1) and (10), clean water retained in the purification water pool 3 is again made to flow in the hollow water area 2 through the contact oxidation dike 1 so as to purify the water area of the hollow water area 2 as a result of a rise in the water level of the exterior water area 4.

By repeating the operations, the water in the hollow water area 2 is further purified, thus an advanced serene purification water area is created.

The contact oxidation dike 1 that forms the hollow water area 2 is a permeation dike formed of a contact oxidation material having multigaps such as known rubble, concrete blocks, or the like, and this purification dike 1 preys on and adsorbs dirt in the water by creatures adhered to the surface so as to clean the water permeated through the contact oxidation dike 1. This is a contact oxidation process of the hollow water area 2.

Nutrients (pollutants) in the water accumulated in the contact oxidation dike 1 formed as such are taken in by creatures such as crustaceans and mollusks that inhabit the contact oxidation material having multigaps, and furthermore, these creatures are preyed on by large-sized fish and shellfish and are treated in the course of ecological circulation while repeating accumulation, decomposition, and movement, so that unlike the conventional chemical water treatment, scum (waste) resulting from improvement in water quality is minimal.

In addition, the water area of the hollow water area 2 enclosed and shut off by such a contact oxidation dike 1 is a serene water area without waves or streams, wherein sedimentation is actively carried out so that suspended matter is removed by precipitation purification.

When the water has been cleaned and sunlight reaches the bottom, the sunlight decomposes bottom mud and allows a multitude of algae to thickly grow deep in the water, so that photosynthesis is actively carried out and a large amount of oxygen is discharged in the water.

Moreover, nitride and phosphorous dissolved in the water are also converted to phytoplankton by the action of sunlight, and as a result of a fall in the exterior water level, the phytoplankton permeate through the contact oxidation dike 1 and are removed by the action thereof.

Furthermore, wave aeration of the contact oxidation dike 1 is enhanced by utilizing wave energy so as to enrich dissolved oxygen in the water.

In order to maintain the conditions described above, concretely, (1) known seashells, sand worms, sea cucumbers, crabs, shrimp, and the like are released at the bottom of the purification water pool 3 and allowed to take in plankton in water and dirt in bottom mud, and the total water contamination amount B in a water area of the purification water pool 3 is thereby reduced so that the condition of B/C≦1 described above is maintained. In addition, (2) known purifying seaweeds such as eel grass, sargasso, wakame seaweed (Undaria pinnatifida), and kelp are transplanted at the bottom of the purification water pool 3, and in a shoal, aquatic plants such as reeds and mangroves are transplanted, and these are allowed to take in nutrient salts such as nitride and phosphorous in a water area of the purification water pool 3 so as to activate carbon dioxide assimilation at the bottom, and the total water contamination amount B in the water area of the purification water pool 3 is thereby reduced so that the condition of B/C≦1 described above is maintained. (3) Known seaweeds such as laver, wakame seaweed (Undaria pinnatifida), and kelp are cultivated and fish and shellfish such as little clams, sea cucumbers, black sea bream, flatfish, mullet, crabs, and shrimp are released in a water area of the purification water pool 3 for making it easy to remove nutrient load substances in the purification water pool 3 by prey by using ecological circulation, and suspended matter and the nutrient load substances are naturally discharged to an exterior water area 4 by wild birds swimming and walking, and the total water contamination amount B in the water area of the purification water pool 3 is thereby reduced so that the condition of B/C≦1 described above is maintained. (4) The bottom of the purification water pool 3 is covered with known sand and gravel so as to reduce pollution discharged from the bottom of the purification water pool 3, and the total water contamination amount B is thereby reduced so that the condition of B/C≦1 described above is maintained. (5) The bottom of the purification water pool 3 is shall owed to an extent that sunlight can reach so as to actively carry out known photosynthesis at the bottom, and the total water contamination amount B in the purification water pool 3 is thereby reduced so that the condition of B/C≦1 described above is maintained. (6) Known abalone, turban shells, oysters, mussels, crabs, shrimp, sand worms, sea cucumbers, and the like are released inside a contact oxidation dike 1 that forms a hollow water area 2 so as to enhance predation of contamination inflows and cleaning of the contact oxidation dike 1, and the total purification capacity C of the hollow water area 2 is increased so that the condition of B/C≦1 described above is maintained. (7) Known aeration is carried out outside, interiorly, or inside a dike of a contact oxidation dike 1 that forms a hollow water area 2 so as to enhance ecological circulation in the hollow water area 2, and the total purification capacity C of the hollow water area 2 is thereby increased so that the condition of B/C≦1 described above is maintained. (8) By mixing a known purification filter medium such as maifan-stone as a filter medium of a contact oxidation dike 1 that forms a hollow water area 2, the total purification capacity C of the hollow water area 2 is increased so that the condition of B/C≦1 described above is maintained. (9) Known seaweeds such as wakame seaweed (Undaria pinnatifida) and kelp and fish and shellfish such as black sea bream, mullet, crabs, shrimp, and sea cucumbers are released in a water area of the hollow water area 2 and allowed to take in accumulated nutrient load substances in the hollow water area 2 for easily preying on the same by ecological circulation, and the total purification capacity C of the hollow water area 2 is increased so that the condition of B/C≦1 described above is maintained. (10) By installing a hollow water area 2 that forms a serene and advanced purification water area according to the above, a known “sunlight hole system utilizing hollow water area” of Japanese Patent Application No. H09-260788 is formed, and by transmitting a large amount of sunlight to a deep layer part of the hollow water area 2, photosynthesis is actively carried out to supply a low layer part with a large amount of dissolved oxygen, and the total purification capacity C of the hollow water area 2 is increased so that the condition of B/C≦1 described above is maintained.

Since the water area in and out of the hollow water area 2 is maintained with abundant oxygen as such, ecological circulation is actively carried out, so that the water in and out of the hollow water area 2 is further cleaned. By repeating such natural purification, the water in and out of the hollow water area 2 is purified in an advanced manner.

### BRIEF DESCRIPTION OF THE DRAWINGS

FIG. 1 is a plan view of an advanced purification system utilizing closed water areas by hollow water areas in a shore area;

FIG. 2 is a plan view of an advanced purification system utilizing a closed water area by a hollow water area in a closed water area enclosed by a land area;

FIG. 3 is a plan view of an advanced purification system utilizing a closed water area by a hollow water area, utilizing a purification water channel;

FIG. 4 is a plan view of an advanced purification system utilizing a closed water area by a hollow water area, utilizing a shallow water area;

FIG. 5 is a plan view of an advanced purification system utilizing a closed water area by a hollow water area, utilizing a breakwater dike;

FIG. 6 are sectional views of the plan views of FIGS. 1 to 5, respectively; wherein

FIG. 6A is a section along a-a, where a purification water pool 3 utilizing a conventional dike 8 is formed, showing a condition of a high-order process progressing while water permeates through a contact oxidation dike 1 as a result of a rise in the exterior water level and flows again into a hollow water area 2;

FIG. 6B is a section along b-b, where a purification water pool 3 utilizing a breakwater dike 7 having multigaps is formed, showing a condition of a high-order process progressing while water permeates through a contact oxidation dike 1 as a result of a rise in the exterior water level and flows again into a hollow water area 2;

FIG. 6C is a section along c-c, where a purification water pool 3 utilizing land or shore is formed, showing a condition of a high-order process progressing while water permeates through a contact oxidation dike 1 as a result of a rise in the exterior water level and flows again into a hollow water area 2;

FIG. 6D is a section along d-d, where a purification water pool 3 utilizing a contact oxidation dike of a neighboring hollow water area of a water area is formed, showing a condition of a high-order process progressing while water permeates through a contact oxidation dike 1 as a result of a rise in the exterior water level and flows again into a hollow water area 2;

FIG. 6E is a section along e-e, where a purification water pool 3 utilizing an embankment of stone masonry or the like is formed, showing a condition of a high-order process progressing while water permeates through a contact oxidation dike 1 as a result of a rise in the exterior water level and flows again into a hollow water area 2;

FIG. 6F is a section along f-f, where a purification water pool 3 utilizing an embankment of gabions is formed, showing a condition of a high-order process progressing while water permeates through a contact oxidation dike 1 as a result of a rise in the exterior water level and flows again into a hollow water area 2;

FIG. 6I is a section along i-i, where a purification water pool 3 utilizing a shoal is formed, showing a condition of a high-order process progressing while water permeates through a contact oxidation dike 1 as a result of a rise in the exterior water level and flows again into a hollow water area 2;

FIG. 6J is a section along j-j, where a purification water pool 3 for a shoal 11 has been developed is formed, showing a condition of a high-order process progressing while water permeates through a contact oxidation dike 1 as a result of a rise in the exterior water level and flows again into a hollow water area 2;

FIG. 6K is a section along k-k, where a purification water pool 3 utilizing a breakwater dike 10 having gaps and a low top surface is formed, showing a condition of a high-order process progressing while water permeates through a contact oxidation dike 1 as a result of a rise in the exterior water level and flows again into a hollow water area 2; and

FIG. 6L is a section along 1-1, where a purification water pool 3 utilizing a breakwater dike 9 having gaps and a high top surface is formed, showing a condition of a high-order process progressing while water permeates through a contact oxidation dike 1 as a result of a rise in the exterior water level and flows again into a hollow water area 2.

### DETAILED DESCRIPTION OF THE INVENTION

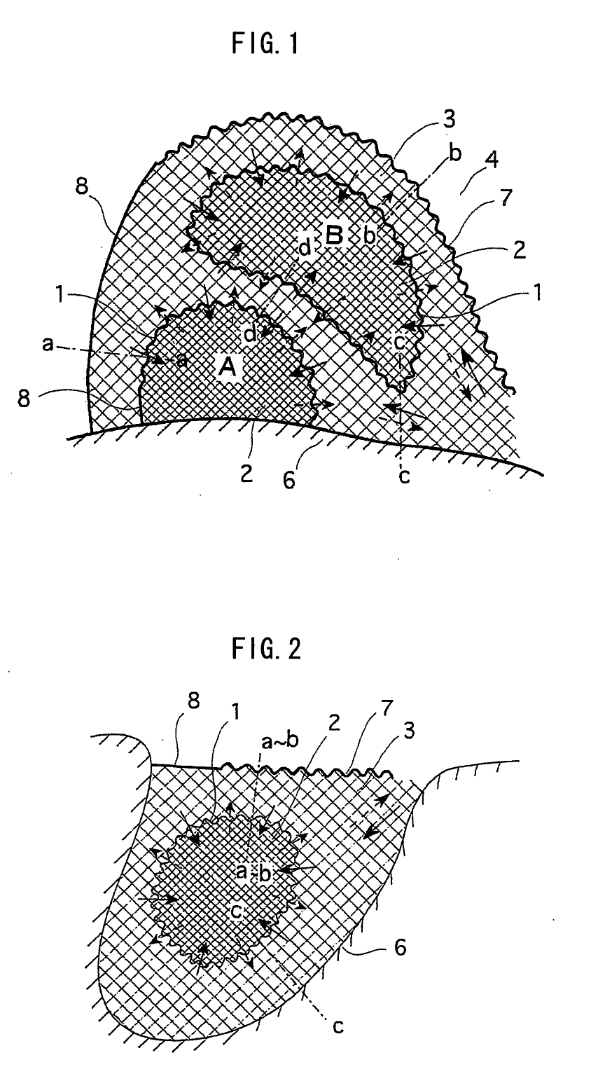

In order to describe the present invention in greater detail, the present invention will be explained with reference to the accompanying drawings. FIGS. 1 to 5 are hollow water areas 2 enclosed and shut off by contact oxidation dikes 1 formed in water areas having changes in the water level, and these are known purification systems.

When a purification water pool 3 is installed outside the hollow water area 2 formed as such, as a result of a fall in an exterior water area 4, clean water permeated through the contact oxidation dike 1 flows out of an interior water area of the hollow water area 2 and is reserved in the purification water pool 3.

In this condition, when there is a rise in the water level of the exterior water area 4, the clean water in the purification water area 3 around the hollow water area 2 again flows in the water area of the hollow water area 2 through the contact oxidation dike 1 so as to further purify the water area of the hollow water area 2. By repeating the actions described above, the water in the hollow water area 2 is further cleaned.

However, a water area of the purification water pool 3 being a closed water area is adjacent to an exterior polluted water area or land area, due to inflows of a river and polluted water such as rainwater from the exterior water area 4 or land area, the purification water pool 3 is polluted.

Therefore, in a relationship having a retention capacity Qb of the purification water pool 3 being a closed water area that sufficiently retains a water quantity Qc of clean water flowing out from the hollow water area 2 to the exterior water area as a result of a fall in the exterior water area 4, that is, Qb>Qc, where a water contamination emission is provided as Σbi=B, a total purification capacity of the hollow water area 2 is provided as Σci=C, and under a condition of B/C≦1, when the water level of the exterior water area 4 again rises, the water in the interior water area of the hollow water area 2 is further purified by again taking clean water retained in the purification water pool 3 through the contact oxidation dike 1 into the hollow water area 2.

This is an advanced purification system utilizing a closed water area by a hollow water area.

Thus, FIG. 1 is an advanced purification system utilizing closed water areas by hollow water areas, for which two hollow water areas A and B are installed in a shore water area, and the purification water pool 3 enclosed by a breakwater dike 7 or the like constructed by a known conventional dike 8, known concrete blocks, rubble, or the like is formed outside purification dikes that form the hollow water areas.

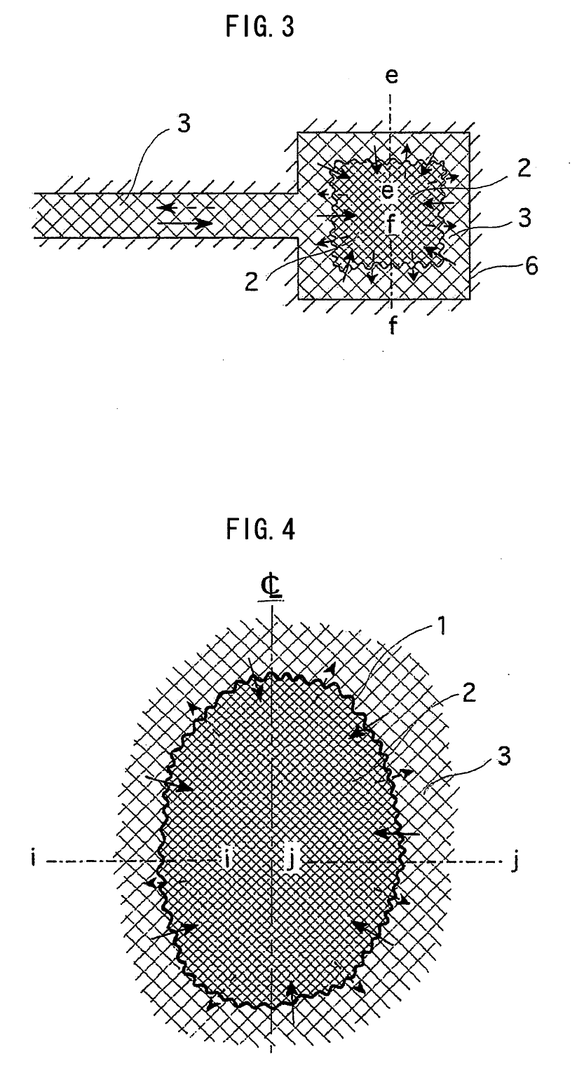

FIG. 2 is an advanced purification system utilizing a closed water area by a hollow water area, for which the hollow water area 2 is installed in a closed water area enclosed by a land area 6, and adjustment is carried out by a breakwater dike 7 or the like constructed by a known conventional dike 8, known concrete blocks, rubble, or the like in order to make the purification water pool 3 efficiently function.

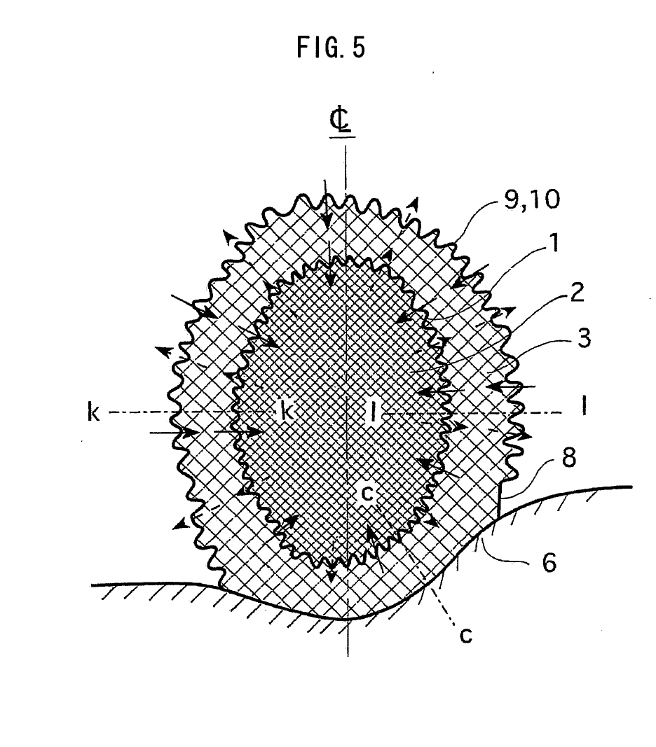

FIG. 3 is an advanced purification system utilizing a closed water area by a hollow water area utilizing a purification water channel, wherein the purification water channel is utilized for the purification water pool 3.

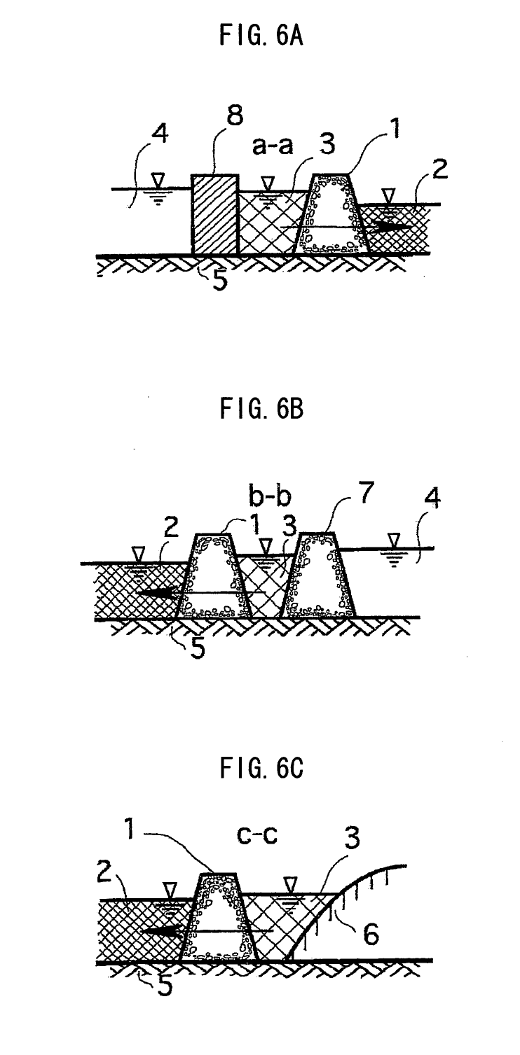

FIG. 4 is an advanced purification system utilizing a purification system in an exterior water area by a hollow water area utilizing a shoal, for which, in a deep water area, a shoal development 5 is carried out at an exterior water area with known earth and sand, concrete blocks, rubble, or the like in the exterior water area and known rubble or blocks are paved in a shoal. Alternately, aquatic plants such as reeds, mangroves, and the like and algae such as eel grass and sargasso are transplanted so as to prevent clean water that has flowed out of the hollow water area 2 from diffusing and wandering.

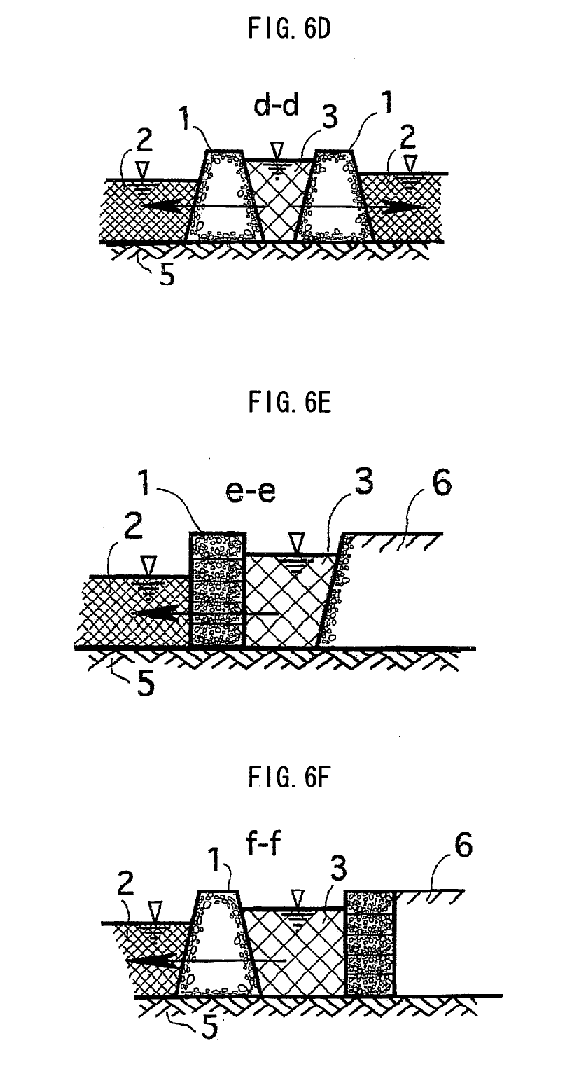

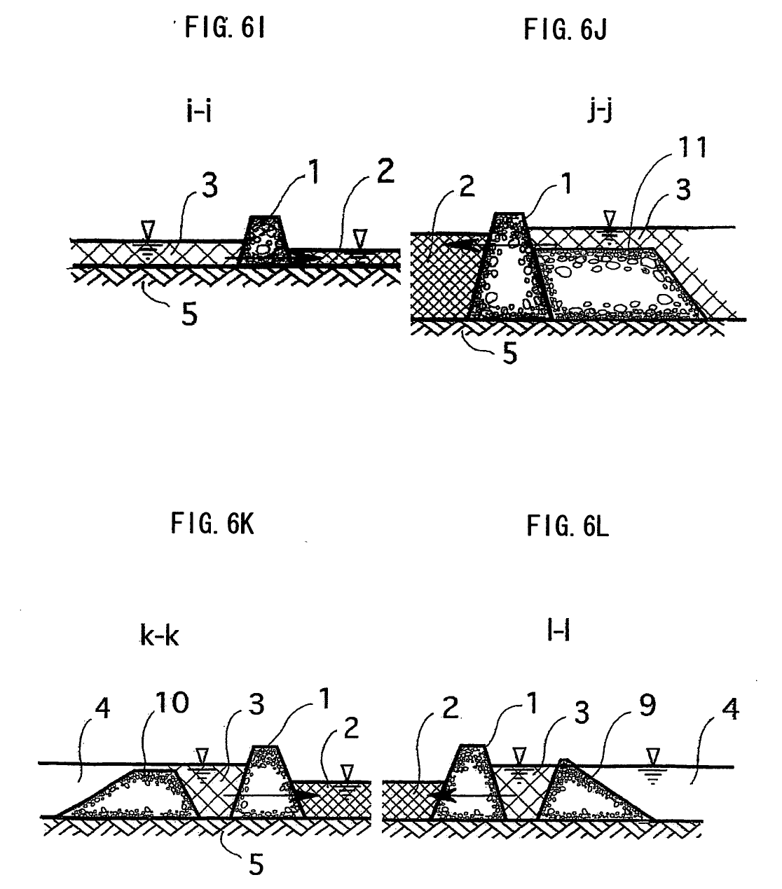

FIG. 5 is an advanced purification system for a water area utilizing a closed water area by a hollow water area by the purification water pool 3 by a closed water area utilizing breakwater dikes 9 and 10, wherein the purification water pool 3 is formed by utilizing breakwater dikes constructed by known concrete blocks, rubble, or the like as the breakwater dikes 9 and 10.

Due to industrial growth and concentration of population in urban areas, destruction of water quality environments has become a major problem.

Under such circumstances, the present system is provided for purifying water by efficiently utilizing natural energies of waves, tides, sunlight, natural gravity, ecological vitality, and the like.

Therefore, unalike the conventional chemical water treatment and mechanical water treatment, the present system requires a small running cost no matter how great amount of water this treats (purifies water). Furthermore, since water is treated in the course of natural ecological circulation, no scum remains after water treatment, which is also a remarkable feature of the present system.

Consequently, it is possible to create a very clean serene purification water are a relatively easily, and the present system has a wide range of industrial applications such as environmental creation, mitigation, tourist and underwater leisure facilities including a (seaside) bathing area and a natural aquarium, and tertiary sewage treatment.

1. An advanced purification system utilizing a closed water area by a hollow water area, in a relationship of Qb>Qc having a retention capacity Qb of a purification water pool being a closed water area that sufficiently retains a water quantity Qc of clean water flowing out from a hollow water area to an exterior water area as a result of a fall in the exterior water area, where respective contamination emissions in the purification water pool being a closed water area being provided as bi, a total water contamination emission in the entire water area of the purification water pool being Σbi=B, and where respective water purification capacities being provided as ci, a total purification capacity of the hollow water area as a whole being Σci=C, for again taking clean water retained in the purification water area through the purification dike into the hollow water area as a result of a rise in a water level of the exterior water area by setting a scale of the hollow water area or practicing operations under a condition of B/C≦1, so as to further purify water in the hollow water area, wherein
by repeating the above-described operation, water in and out of the hollow water area is further purified, and a serene and advanced purification water area is created in the hollow water area.

2. The advanced purification system utilizing a closed water area by a hollow water area according to claim 1, wherein
known bivalves, sand worms, sea cucumbers, crabs, shrimp, and the like are released at a bottom of the purification water pool and allowed to take in plankton in water and dirt in bottom mud, and the total water contamination amount B in a water area of the purification water pool is thereby reduced so that the condition of B/C≦1 is maintained.

3. The advanced purification system utilizing a closed water area by a hollow water area according to claim 1, wherein
transplanted are known purifying seaweeds such as eel grass, sargasso, wakame seaweed (Undaria pinnatifida), and kelp at a bottom of the purification water pool, and in a shoal, aquatic plants such as reeds and mangroves, and these are allowed to take in nutrient salts such as nitride and phosphorous in a water area of the purification water pool so as to activate carbon dioxide assimilation in the bottom, and the total water contamination amount B in the water area of the purification water pool is thereby reduced so that the condition of B/C≦1 is maintained.

4. The advanced purification system utilizing a closed water area by a hollow water area according to claim 1, wherein
known seaweeds such as laver, wakame seaweed (Undaria pinnatifida), and kelp and fish and shellfish such as seashells, sea cucumbers, black sea bream, flatfish, mullet, crabs, and shrimp are released in a water area of the purification water pool for making it easy to remove nutrient load substances in the purification water pool by prey by using ecological circulation, and suspended matter and the nutrient load substances are naturally discharged to an exterior water area by wild birds swimming and walking, and the total water contamination amount B in the water area of the purification water pool is thereby reduced so that the condition of B/C≦1 is maintained.

5. The advanced purification system utilizing a closed water area by a hollow water area according to claim 1, wherein
a bottom of the purification water pool is covered with known sand and gravel so as to reduce pollution discharged from the bottom of the purification water pool, and the total water contamination amount B is thereby reduced so that the condition of B/C≦1 is maintained.

6. The advanced purification system utilizing a closed water area by a hollow water area according to claim 1, wherein
a bottom of the purification water pool is shallowed to an extent that sunlight can reach so as to actively carry out known photosynthesis at the bottom, and the total water contamination amount B in the purification water pool is thereby reduced so that the condition of B/C≦1 is maintained.

7. The advanced purification system utilizing a closed water area by a hollow water area according to claim 1, wherein
known abalone, turban shells, oysters, mussels, crabs, shrimp, sand worms, sea cucumbers, and the like are released inside a contact oxidation dike that forms a hollow water area so as to enhance predation of contamination inflows and cleaning of the contact oxidation dike, and the total purification capacity C of the hollow water area is increased so that the condition of B/C≦1 is maintained.

8. The advanced purification system utilizing a closed water area by a hollow water area according to claim 1, wherein
known aeration is carried out outside, interiorly, or inside a dike of a contact oxidation dike that forms a hollow water area so as to enhance ecological circulation in the hollow water area, and the total purification capacity C of the hollow water area is increased so that the condition of B/C≦1 is maintained.

9. The advanced purification system utilizing a closed water area by a hollow water area according to claim 1, wherein
by mixing a known purification filter medium such as maifan-stone as a filter medium of a contact oxidation dike that forms a hollow water area, the total purification capacity C of the hollow water area is increased so that the condition of B/C≦1 is maintained.

10. The advanced purification system utilizing a closed water area by a hollow water area according to claim 1, wherein
in a water area of the hollow water area, known seaweeds such as wakame seaweed (Undaria pinnatifida) and kelp and fish and shellfish such as black sea bream, mullet, crabs, shrimp, and sea cucumbers are released and allowed to take in accumulated nutrient load substances in the hollow water area for easily preying on the same by ecological circulation, and the total purification capacity C of the hollow water area is increased so that the condition of B/C≦1 is maintained.

11. The advanced purification system utilizing a closed water area by a hollow water area according to claim 1, wherein
by installing a hollow water area that forms a serene and advanced purification water area, known “sunlight hole system utilizing hollow water area” of Japanese Patent Application No. H09-260788 is formed, and by transmitting a large amount of sunlight to a deep layer part of the hollow water area, photosynthesis is actively carried out so as to supply a low layer with a large amount of dissolved oxygen, and the total purification capacity C of the hollow water area is increased so that the condition of B/C≦1 is maintained.
